(19) United States
(12) Patent Application Publication
(10) Pub. No.: US 2004/0118637 A1
(43) Pub. Date: Jun. 24, 2004

(54) Power steering service apparatus and method

(75) Inventor: Patrick Dixon, Gilbert, AZ (US)

Correspondence Address: Law Office of Terry L. Miller, 24832 Via San Fernando, Mission Viejo, CA, 92692, US

(73) Assignee: PD Ventures, LLC

(21) Appl. No.: 10/329,266

(22) Filed: Dec. 24, 2002

(51) Int. Cl. F16C 3/14

(52) U.S. Cl. 184/1.5

(57) ABSTRACT

A fail-safe service machine for the power steering system of automotive vehicles includes a pair of pumps each driven by electrical power from a vehicle under service, and a suction/delivery probe extending into the power steering system reservoir of the vehicle to remove old power steering fluid, and to simultaneously deliver new power steering fluid as a downwardly directed jet or stream of fluid extending toward the bottom of the power steering fluid reservoir.

### BACKGROUND OF THE INVENTION

### Field of the Invention

This invention is in the field of apparatus and methods for service of an automotive power steering system. That is, this invention relates to a machine and method for removing the old power steering fluid from a power steering system, and for replacing the old fluid with new fluid at the same time. The apparatus and method are so designed and configured that damage to the power steering system from running dry cannot happen, even as a result of inattention by a service technician operating the service machine.

Present service machines for power steering systems either introduce the new power steering fluid near the top of the reservoir of the system, and withdraw the old fluid from the reservoir bottom of the reservoir, or vice versa. In former case, the power steering system can inadvertently be run dry of fluid in the even if the servicing technician is inattentive. In the latter case, a specialized probe is required which may have to be sized and configured to the particular size and shape of the reservoir of a particular power steering system.

A desirable improvement would be to provide a power steering system service machine in which a probe of the machine has a universal configuration, and which still provides for protection of the power steering system against running dry of power steering fluid, even if the service technician is inattentive.

### SUMMARY OF THE INVENTION

In view of the deficiencies of the conventional technology, it is an object for this invention to avoid one or more of these deficiencies.

Further in view of the above, it is desirable and is an object of this invention to provide an improved fail-safe power steering service machine which allows the old fluid to be removed from a power steering system while simultaneously being replaced by new fluid, and with no risk that the power steering pump of the system can be damaged by dry running.

Accordingly, the present invention according to a particularly preferred exemplary embodiment of the invention provides a power steering service machine having a duality of pumps operating simultaneously, one pump withdrawing fluid via a first conduit from a first level above the bottom of the power steering pump fluid reservoir of a power steering system being serviced, and the other pump delivering new power steering fluid from a source thereof via a second conduit to the reservoir of the power steering pump at a second level substantially the same as the first level. In order to substantially prevent mixing of new fluid with old fluid in the reservoir, it is desirable that the new fluid be introduced into the reservoir as a downwardly directed stream or jet of fluid, and that this downwardly directed stream or jet issuing from the second conduit be spaced from the first conduit at which old fluid is ingested by the machine from the fluid reservoir. Still further, it is desirable potentially to provide a shield member immersed in the power steering fluid and interposed in spaced relationship between the openings of the two conduits within the power steering fluid reservoir of the system being serviced. This shield member is most desirably a structural component of the service probe of the service machine, including also the first and second conduits.

An advantage of the present invention is that its configuration and operation results in the absolute failure safe operation of the present power steering service machine so far as possible damage to the power steering pump of the power steering system because of dry running is concerned.

Additional objects and advantages of the present invention will be apparent from a reading of the following detailed description of a singular exemplary preferred embodiment of the invention when taken in conjunction with the appended drawing Figures. Also, a better understanding of the present invention will be obtained from reading the following description of a single preferred exemplary embodiment of the present invention when taken in conjunction with the appended drawing Figures, in which the same features (or features analogous in structure or function) are indicated with the same reference numeral throughout the several views. It will be understood that the appended drawing Figures and description here following relate only to one or more exemplary preferred embodiments of the invention, and as such, are not to be taken as implying a limitation on the invention. No such limitation on the invention is implied, and none is to be inferred.

### BRIEF DESCRIPTION OF THE DRAWING FIGURES

FIG. 1 provides a schematic representation of an automotive power steering system; and

FIG. 2 is a highly diagrammatic illustration of a reservoir of the power steering system with a suction/delivery probe of the present invention shown in place in this reservoir during service of the power steering system. A dual pump service machine embodying the present invention is also shown schematically.

### DETAILED DESCRIPTION OF AN EXEMPLARY PREFERRED EMBODIMENT

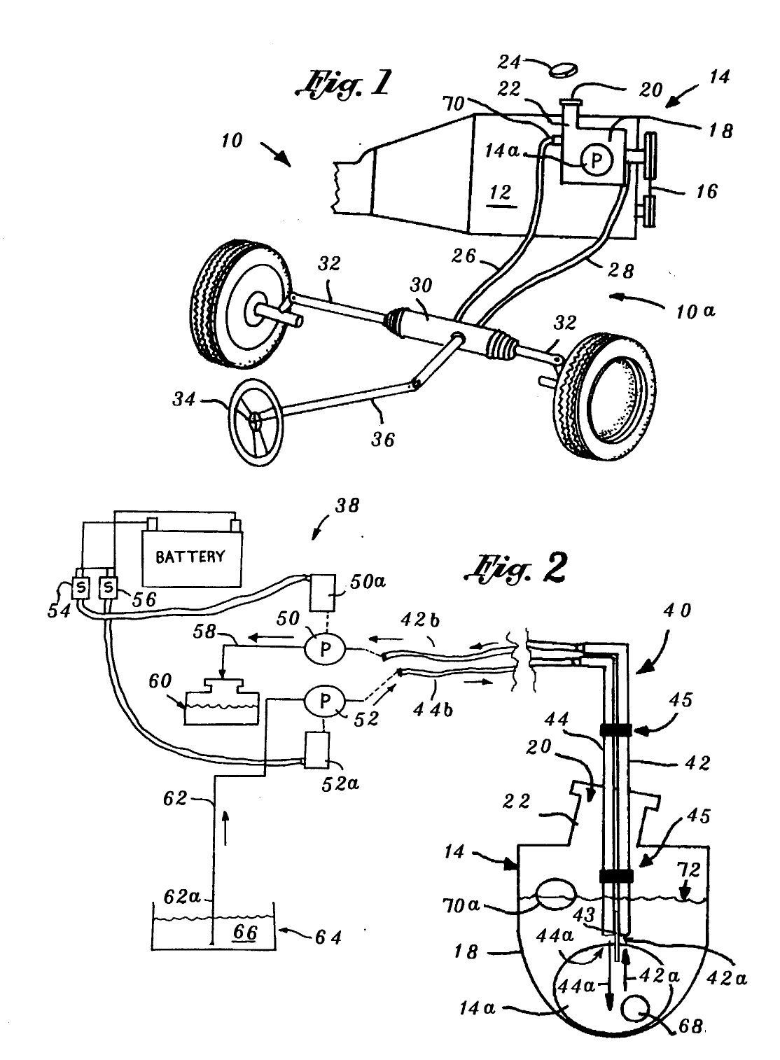

Viewing first FIG. 1, a vehicle 10 with a power steering system 10a includes an engine 12 driving a power steering pump 14 by means of a belt 16. This power steering pump 14 includes a reservoir portion 18 disposed generally above the actual pumping portion (indicated with the dashed circle, the character “P”, and the numeral 14a) of the power steering pump 14. Those ordinarily skilled in the pertinent arts will recognize that although the pump 14a and the reservoir 18 may each be a separate structure, which are in that case interconnected by fluid conduits, conventional modern automotive practice provides the reservoir 18 as a structure in surrounding relationship to the pump 14a. The reservoir portion 18 has a fill opening 20, which in the illustrated case is disposed at the upper end of a fill tube 22 closed by a cap 24. Also, a low-pressure hose 26 connects onto a fitting on the body of the reservoir portion 18 in order to allow return of low pressure power steering fluid into this reservoir.

During operation of the engine 12, the pump 14a draws power steering fluid from the reservoir portion 18, and delivers this fluid pressurized via a hose or conduit 28 to a power steering unit 30. The power steering unit 30 is in this case depicted as a power rack-and-pinion type unit, although, of course, the invention is not limited to use with this type or any other type of power steering gear of unit. This power steering unit 30 is connected to the dirigible wheels of the vehicle, for example, by tie rods 32, and has a steering input from a steering wheel 34 via a steering shaft 36.

Now, as is seen in FIG. 2, in order to allow a power steering service machine 38 to be used in exchanging fluid from the power steering system 10a, a suction/delivery probe 40 is inserted into the reservoir portion 18 through the fill opening 20 and along the fill tube 22 into the puddle or volume of power steering fluid 18′ disposed within the reservoir 19. The suction/delivery probe 40 includes a pair of side-by-side substantially parallel, shape retaining, and possible rigid conduits 42, 44. The conduits 42, 44 may be of flexible nature if desired, but they are most preferably of shape-retaining nature so that the relationship of the lower end openings 42a, 44a of these conduits can be reliably maintained. Preferably, the conduits 42, 44 are mutually secured to one another by a clip member 45 (or by a pair of such clip members) encircling both of these conduits. As is seen in FIG. 2, the lower end openings 42a, 44a of the conduits 42, 44 are each at substantially the same level within the puddle of power steering fluid 18′ disposed in the reservoir 18. Also, preferably, the openings 42a and 44a are spaced slightly apart, although this mutual spacing between the openings 42a and 44a may be as little as the wall thickness of the two tubes 42 and 44. More preferably, the openings 42a and 44a are spaced somewhat further apart than that spacing required by the wall respective thickness of the tubes 42 and 44. As is seen in FIG. 2, an optional depending flow shield member 43 may be captured between the lower extent of the tubes 42 and 44, and may depend between the openings 42a and 44a in order to substantially prevent suction existing on tube 42 from ingesting new power steering fluid delivered along tube 44.

Further attention to FIG. 2 will show that the machine 10a includes a pair of pumps 50, 52 each driven by a respective one of a pair of electric motors 50a, 52a. The motors 50a, 52a are each controlled by a respective one of a pair of switches 54, 56, and a battery of the vehicle 10 is utilized as a power source for the motors 50a, 52a, and the associated pumps 50 52. Pump 50 draws fluid from conduit 42 via an interconnecting flexible hose 42b (noting that FIG. 2 is drawn at different sizes or scales for convenience of illustration on the left hand side of this Figure, versus the right hand side), and pump 52, delivers fluid to conduit 44 via an interconnecting flexible hose 44b, both of which are indicated on FIG. 2 by the fluid flow direction arrows associated with these elements. A hose or conduit 58 leads from pump 50 to a waste fluid container 60; while a hose or conduit 62, having a suction tube portion 62a is inserted into a container 64 of new power steering fluid 66 and connects to the pump 52.

Still viewing FIG. 2, it is seen that the pump portion 14a includes a fluid intake port 68 disposed near the bottom of reservoir 18, while the low pressure hose 26 connects to a fitting 70 (best seen in FIG. 1) providing a port 70a by which low pressure fluid is returned to reservoir 18. As is seen best in FIG. 2, the designed fluid level 72 in reservoir 18 is above port 68, and is about at the level of port 70a. During operation of the engine 12 of the vehicle 10, the pump portion 14a draws fluid in at port 68, and delivers this fluid pressurized via the hose or conduit 28, as was explained above in connection with FIG. 1. The low pressure fluid from the power steering unit 30 is returned to the reservoir 18 via hose 28, fitting 70, and port 70a.

Now, when the machine 38 is to be used to service the power steering system 14, the suction/delivery probe 40 is inserted into the reservoir 18a, and the pump 50 is operated by closure of switch 54 to withdraw fluid down to the level of lower end opening 42a. As is noted, this level is still above the level of pump inlet port 68. Next, the engine 12 is started, operating pump 14a, and the two pumps 50 and 52 then both also operated by closure now also of the switch 56. With both pumps 50 and 52 operating, new power steering fluid is delivered via probe 40 to the end opening 44a and is discharged from this opening as a downwardly directed jet or stream (indicated by arrowed numeral 44b) of new power steering fluid. This jet or stream 44b proceeds generally to a lower level in the reservoir 18 so that the new fluid is generally disposed adjacent to the inlet port 68 of the pump portion 14a. Conversely, as fluid from the power steering system 10a is returned into the reservoir 18 via port 70a, it is available to be suctioned from this reservoir at inlet 42a of tube 42 by operation of pump 50. The ingestion or suctioning of the fluid from the reservoir 18 is indicated on FIG. 2 by the arrowed numeral 42b. It will be understood that in contrast to the jet or stream of downwardly directed new power steering fluid issuing from outlet 44a, the suction fluid flow field adjacent to inlet 42a of tube 42 is much more generalized and not directional. Thus, this inlet 42a tends to draw in fluid from all around and below this inlet 42a. At first, essentially all of the fluid returned into the reservoir 18 will be old fluid which it is desired to withdraw from the system 10a. As fluid exchange proceeds, the fluid ingested at inlet 42a will be a mix of old and new fluid, which is expected and is acceptable. Further, during this fluid exchange process, the optional shield member 43 may be employed to further isolate the downwardly directed jet 44b of new power steering fluid from the generalized suction fluid flow field (arrow 42b) flowing to inlet 42a.

In order to facilitate removal of essentially all of the old power steering fluid from the system 10a, and replacement of this old fluid with new power steering fluid, it is desirable to exercise the steering unit 30, so that the hydraulic actuator of this steering unit will be run from one extreme of its movement to the other at least once, and preferably several times. Thus, the old fluid is discharged from the two sides of this double-acting actuator 30, and is replacing with new fluid received into the reservoir 18 via conduit 44 and into pump portion 14a via port 68. As this exercise of the power steering unit 30 is conducted by turning the steering wheel 34 from one extreme of its movement to the other and back again, the old power steering fluid will be removed from the steering unit 30 to be replaced by new fluid as explained above. However, it is easily seen that as old fluid from the power steering system 10a is returned to the reservoir 18 it has an opportunity for admixture with the new fluid in this reservoir.

The Applicant has, however, discovered that by use of the suction/delivery probe 40 as depicted and described herein, a generally satisfactory stratification of the power steering fluid in the reservoir 18 can be maintained, with new fluid being delivered in the form of a downwardly directed jet or stream of fluid, so that the new power steering fluid is mostly disposed at or adjacent to the lower level adjacent to the inlet port 68 of the pump portion 14a. Conversely, old fluid returned into the reservoir 18 via port 70a is introduced less directionally, and more generally, and is at an upper level of the reservoir 18 where it is available to be suctioned out by conduit 42. Further, consideration of the way the new power steering fluid is introduced intermediate of the top and bottom of the reservoir 18, but is introduced as a downwardly directed jet or stream toward the bottom of the reservoir, may suggest that the new power steering fluid fills the reservoir 18 from the bottom, and the old fluid is welled up by new fluid from below, so that the old fluid is suctioned to the waste container by conduit 42.

Also, in that part of the service procedure during which the pump 14a is operating (i.e., because the engine 12 of the vehicle 10 has been started and is running), and during which the power steering system 10a is exercised to bring the old fluid from the system to the reservoir 18, the pump 14a is drawing substantially only new power steering fluid from the bottom of reservoir 18 via intake port 68. Thus, the pump 14a by immediately taking into the power steering system some of the new fluid as this new fluid is delivered from conduit 44, prevents this new fluid from being mixed with old fluid, and actually assists in improving the economy of flushing operation that can be expected from use of the machine 10. Of course, perfect separation of the new power steering fluid and old power steering fluid is not expected with use of the machine 38 and probe 40. The Applicant has determined that to the extent that some mixing of old and new fluid in the reservoir (as well as such mixing of the old and new fluid as undoubtedly takes place at other locations of the power steering system 10a as the new fluid flushes the old fluid out), indicates that about twice as much new fluid be provided into the reservoir 18 during a service procedure as the system 10a holds when full. Thus, about one system volume of old fluid is withdrawn from the system 10a, along with about one system volume of mixed new and old fluid. The fluid remaining in the system 10a after a service according to this invention is substantially new fluid.

Further to the above, it will be apparent that the power steering system 10a cannot ever be damaged by dry running of the pump portion 14a. As an initial consideration, the end 42a of the suction conduit 42 is always positioned well above the lower extent of the reservoir 18, and well above the inlet port 68 for the pump portion 14a. As a result, although the pump portion 14a is uniquely vulnerable to damage by dry running, such dry running can never happen because of the use of the present service machine 38. Even if a user of the machine 38 allows the reservoir 64 to run completely dry of new power steering fluid, and still allows the machine 38 and vehicle 10 to run, the reservoir 18 will have a fluid “puddle” as deep as the level of end opening 42a above intake port 68. This fluid “puddle” is more than adequate to safeguard the pump 14 against damage from dry running.

After the service of the power steering system 10a is completed, the probe 40 is removed from the reservoir 18, and the machine 38 is disconnected from the battery of the vehicle. The cap 24 is replaced on fill opening 20, and the vehicle is then ready to return to service.

While the present invention has been depicted, described, and is defined by reference to a single particularly preferred embodiment of the invention, such reference does not imply a limitation on the invention, and no such limitation is to be inferred. The invention is capable of considerable modification, alteration, and equivalents in form and function, as will occur to those ordinarily skilled in the pertinent arts. For example, it is apparent that the probe 40 may be used without the optional shield member 43. Accordingly, the depicted and described preferred embodiment of the invention is to be understood as being exemplary only, and is clearly not exhaustive of the scope of the invention. Consequently, the invention is intended to be limited only by the spirit and scope of the appended claims, giving full cognizance to equivalents in all respects.

I claim:

1. A fail-safe probe structure for use in servicing an automotive power steering system, said power steering system being of the type having a power steering pump and a reservoir holding power steering fluid, the reservoir having an upper reservoir opening to ambient and a design fluid level for power steering fluid in the reservoir, the power steering pump being adapted to withdraw power steering fluid from a lower portion of the reservoir and returning power steering fluid to the reservoir, said probe structure being effective both for simultaneously removing old power steering fluid from the reservoir while replacing new power steering fluid into the reservoir, and always maintaining a sufficient puddle of power steering fluid in a lower portion of the reservoir so that the power steering pump cannot be subjected to dry running, said probe structure comprising:
a duality of shape-retaining elongate and generally parallel conduit members arranged generally in side-by-side spaced relationship, said probe structure being sized and adapted for insertion of a portion of said duality of conduit members though said upper reservoir opening and into said reservoir,
a first and a second of said duality of conduit members each having a respective lower end opening disposed substantially at the same level within the reservoir; said first conduit member of said duality of conduit members delivering new power steering fluid into said reservoir from said respective lower end opening as a downwardly directed jet of fluid, and said second conduit member of said duality of conduit members receiving power steering fluid from said reservoir at said respective lower end opening,
whereby said first conduit member delivers new power steering fluid toward the lower portion of the reservoir in said downwardly directed jet of new power steering fluid, there to be withdrawn from the reservoir by the power steering pump; and said second conduit member is effective to receive old power steering fluid from the reservoir at said respective lower end opening thereof at a higher extent of said reservoir, thus to reduce mixing of new power steering fluid with old power steering fluid within said reservoir.

2. The probe structure of claim 1 wherein said probe structure extends downwardly in the reservoir so that said respective lower end openings thereof are spaced intermediate of a lower extent of said reservoir and said design fluid level within said reservoir.

3. The probe structure of claim 1 wherein said first and said second conduit members are spaced a determined distance apart so that new power steering fluid from said downwardly directed jet of new power steering fluid substantially does not flow into the lower end opening of said second conduit member.

4. The probe structure of claim 1 further including a shield member interposed and depending between said respective lower end openings of said first and second conduit members, so that said shield member separates said downwardly directed jet of new power steering fluid from said lower end opening of said second conduit member.

5. A fail-safe machine for service of an automotive power steering system having a power steering pump and a power steering fluid reservoir, the power steering fluid reservoir having an upper opening to ambient and a design power steering fluid level, and the power steering pump ingesting power steering fluid from a lower extent of the reservoir, said machine comprising:
a pair of fluid moving devices, one of said pair of fluid moving devices moving new power steering fluid from a source thereof into the power steering fluid reservoir via a probe structure, and the other of said pair of fluid moving devices simultaneously removing old power steering fluid from the power steering fluid reservoir via said probe structure;
said probe structure including a pair of conduits each extending into the power steering fluid reservoir, each of said pair of conduits having a respective lower end opening, and said respective lower end openings being at substantially the same level within said reservoir, a first of said pair of conduits receiving new power steering fluid and discharging this new power steering fluid in the form of a downwardly directed jet issuing from the respective lower end opening of said first conduit; and the other of said pair of conduits receiving power steering fluid from said reservoir at said lower end opening thereof.

6. The machine of claim 5 wherein each of said pair of fluid moving devices includes a respective pump is driven by a separate motor.

7. The machine of claim 6 wherein said separate electric motors are driven by electrical power from a vehicle while the vehicle is having the power steering system thereof serviced by said machine.

8. A fail-safe method of servicing a power steering system of an automotive vehicle, said method comprising steps of:
simultaneously removing old power steering fluid from a fluid reservoir of the power steering system while delivering new power steering fluid into the fluid reservoir;
delivering the new power steering fluid into a lower extent of the fluid reservoir in the form of a downwardly directed free jet of new power steering fluid introduced into said fluid reservoir at a determined level, while a power steering system pump operates to ingest fluid from the lower extent of the reservoir, which ingested fluid includes at least a portion of the new power steering fluid delivered into the fluid reservoir; and
simultaneously flowing power steering fluid from the fluid reservoir substantially at said determined level such that only a portion but not all of the power steering fluid in the fluid reservoir can be flowed out of the reservoir, and providing for outflow of old power steering fluid from the reservoir to include old power steering fluid and substantially not include new power steering fluid.

9. The method of claim 8 wherein said steps of: delivering the new power steering fluid into a lower extent of the fluid reservoir in the form of a downwardly directed free jet of new power steering fluid and simultaneously flowing power steering fluid from the fluid reservoir substantially at said determined level includes utilizing a probe structure, forming said probe structure to include a pair of conduits each extending into the power steering fluid reservoir, configuring each of said pair of conduits to have a respective lower end opening, disposing said respective lower end openings at substantially the same level within said reservoir, and reducing mixing of new power steering fluid with old power steering fluid within said reservoir by discharging the new power steering fluid from said first to conduit as a downwardly directed jet; and at the other of said pair of conduits receiving power steering fluid from said reservoir at substantially the same level from which said jet of new power steering fluid issues downwardly into said reservoir.
